(19) United States
(12) Patent Application Publication
(10) Pub. No.: US 2026/0171014 A1
(43) Pub. Date: Jun. 18, 2026

(54) PIXEL DRIVING CIRCUIT AND DRIVING METHOD THEREOF, DISPLAY PANEL AND DISPLAY APPARATUS

(71) Applicant: Everdisplay Optronics (Shanghai) Co., Ltd., Shanghai (CN)

(72) Inventors: Yong LI, Shanghai (CN); Chaohui GU, Shanghai (CN); Zhinan JIA, Shanghai (CN)

(73) Assignee: Everdisplay Optronics (Shanghai) Co., Ltd., Shanghai (CN)

(21) Appl. No.: 18/719,279

(22) PCT Filed: Mar. 1, 2023
(86) PCT No.: PCT/CN2023/079038

§ 371 Date: Jun. 13, 2024

(30) Foreign Application Priority Data
Dec. 12, 2022 (CN) 202211590283.0

(51) Int. Cl. G09G 3/3233; G09G 3/3258; G09G 3/3266; G09G 3/3291

(52) U.S. Cl. CPC G09G 3/3233; G09G 3/3258; G09G 3/3266; G09G 3/3291

(57) ABSTRACT

A pixel driving circuit and a driving method thereof, and a display panel are provided. The circuit includes a light-emitting element, and further includes: an initializing subcircuit, including a capacitor, the initializing subcircuit being configured to respectively perform initialization processing on the capacitor and the light-emitting element; a data writing subcircuit, connected to the initializing subcircuit, the data writing subcircuit being configured to write a data signal voltage into the capacitor; and a light-emitting driving subcircuit, respectively connected to the initializing subcircuit and the data writing subcircuit, the light-emitting driving subcircuit being configured to drive the light-emitting element to emit light; where the data writing subcircuit is connected to the light-emitting driving subcircuit to form a first node; and a potential stabilizing subcircuit, respectively connected to the initializing subcircuit and the data writing subcircuit, the potential stabilizing subcircuit being configured to reset a potential of the first node.

### TECHNICAL FIELD

The present disclosure relates to the technical field of display panels, and particularly, to a pixel driving circuit and a driving method thereof, a display panel and a display apparatus.

### BACKGROUND

Organic light-emitting diode (OLED), with the advantages of low power consumption, low cost, self-emitting, wide viewing angle, and fast response, has become one of the research hotspots in the current field of display. Electronic products in different application scenarios may use different refresh rates for display. For example, a driving manner with a higher refresh rate is used to drive and display dynamic images to ensure the smoothness of the display image, and a driving manner with a lower refresh rate is used to drive and display static images to reduce power consumption.

The OLED display is a current-driven display, so a stable current is required to drive the display to emit light. However, due to the process and the device aging, etc., a threshold voltage (Vth) of the transistor in the pixel circuit is prone to drift, which may cause flickering when the OLED display is displaying at a low refresh rate and affect the visual experience.

It should be noted that the information disclosed in the above background section is only used for enhancing the understanding of the background of the present disclosure, and therefore may include information that does not constitute the prior art known to those of ordinary skill in the art.

### SUMMARY

In view of this, the present disclosure provides a pixel driving circuit and a driving method thereof, a display panel and a display apparatus, which is beneficial for improving the flickering problem of the OLED display at a low frequency and improving the display effect.

According to one aspect of the present disclosure, a pixel driving circuit is provided, where the pixel driving circuit includes a light emitting element, and the pixel driving circuit further includes:
an initializing subcircuit, including a capacitor, where the initializing subcircuit is configured to respectively perform initialization processing on the capacitor and the light-emitting element;
a data writing subcircuit, connected to the initializing subcircuit, where the data writing subcircuit is configured to write a data signal voltage into the capacitor;
a light-emitting driving subcircuit, respectively connected to the initializing subcircuit and the data writing subcircuit, where the light-emitting driving subcircuit is configured to drive the light-emitting element to emit light; where the data writing subcircuit is connected to the light-emitting driving subcircuit to form a first node; and
a potential stabilizing subcircuit, respectively connected to the initializing subcircuit and the data writing subcircuit, where the potential stabilizing subcircuit is configured to reset a potential of the first node.

Optionally, the data writing subcircuit includes a first transistor, the light-emitting driving subcircuit includes a second transistor and a third transistor connected to each other, and the data writing subcircuit includes the third transistor. The first transistor, the second transistor and the third transistor are connected together to form the first node.

Optionally, the initializing subcircuit includes a seventh transistor, and the seventh transistor is respectively connected to the light-emitting element and a third scanning signal; and the potential stabilizing circuit includes an eighth transistor, where a gate of the eighth transistor is connected to the third scanning signal.

Optionally, the light-emitting driving subcircuit is connected to a second reference voltage signal, and the potential stabilizing subcircuit is configured to control the eighth transistor to be conducted during a preset operating period to write the second reference voltage signal into the first node.

Optionally, the initializing subcircuit includes a sixth transistor, the sixth transistor is a dual gate transistor, gates of the sixth transistor are connected to a first scanning signal, a first electrode of the sixth transistor is connected to the capacitor, and a second electrode of the sixth transistor is connected to a first reference voltage signal.

Optionally, the initializing subcircuit is further connected to a first reference voltage signal. During a fourth period of each frame cycle, the seventh transistor and the eighth transistor are conducted, a potential of an anode of the light-emitting element is reset to a potential corresponding to the first reference voltage signal, and the second reference voltage signal is written into the first node.

Optionally, the initializing subcircuit is respectively connected to a first scanning signal and a first reference voltage signal; the data writing subcircuit is respectively connected to a data signal and a second scanning signal; and the light-emitting driving subcircuit is respectively connected to a second reference voltage signal, a fourth scanning signal and a third reference voltage signal.

Optionally, a potential of the first reference voltage signal is the same as a potential of the third reference voltage signal, and a potential of the first reference voltage signal is opposite to a potential of the second reference voltage signal.

Optionally, a voltage corresponding to the second reference voltage signal is greater than a voltage corresponding to the first reference voltage signal, and the voltage corresponding to the second reference voltage signal is greater than a voltage corresponding to the third reference voltage signal.

According to another aspect of the present application, a pixel driving method is provided, which is applied to any of the above pixel driving circuits, and the method includes:
performing initialization processing on the capacitor and the light-emitting element, respectively, by using the initializing subcircuit;
writing a data signal voltage into the capacitor by using the data writing subcircuit;
resetting a potential of the first node by using the potential stabilizing subcircuit; and
driving the light-emitting element to emit light by using the light-emitting driving subcircuit.

According to another aspect of the present application, a display panel is provided, and the display panel includes any of the above pixel driving circuits.

According to another aspect of the present application, a display apparatus is provided, and the display apparatus includes the above display panel.

The beneficial effects of the present disclosure compared to the related art are as follows.

The pixel driving circuit and the driving method thereof, the display panel and the display apparatus provided by the present disclosure enable the transistor in the potential stabilizing subcircuit to be conducted under the control of the third scanning signal Sₙ₊₁ during the resetting of the anode or black insertion phase of the light-emitting element, and reset the potential of the first node by using the second reference voltage signal so that the threshold compensation for the third transistor in the light-emitting driving subcircuit is realized, the problem of the drift of the threshold voltage of the third transistor is improved, the threshold voltage of the third transistor is closer to the standard threshold voltage, and the impact on the magnitude of the current of the light-emitting element when emitting light caused by the drift of the threshold voltage of the third transistor is avoided, thereby improving the flickering problem of the display image and enhancing the display effect.

### BRIEF DESCRIPTION OF THE DRAWINGS

The accompanying drawings herein, which are incorporated in and constitute a part of this specification, illustrate embodiments consistent with the present disclosure and are used in conjunction with the specification to explain the principles of the present disclosure. Obviously, the drawings in the following description are only some embodiments of the present disclosure. For those of ordinary skill in the art, other drawings can also be obtained from these drawings without paying creative effort.

FIG. 1 is a schematic diagram of a module structure of a pixel driving circuit disclosed in an embodiment of the present application;

FIG. 2 is a schematic diagram of a specific structure of a pixel driving circuit disclosed in an embodiment of the present application;

FIG. 3 is a schematic diagram of an operating timing sequence of the pixel driving circuit disclosed in an embodiment of the present application.

### DETAILED DESCRIPTION

Exemplary implementation manners will now be described more comprehensively with reference to the accompanying drawings. However, the exemplary implementation manners may be implemented in various forms and should not be construed as being limited to the implementation manners set forth herein. Rather, these implementation manners are provided so that the present disclosure will be thorough and complete, and the concept of the exemplary implementation manners may be comprehensively conveyed to those skilled in the art. The described features, structures, or characteristics may be combined in any suitable manner in one or more implementation manners. In the following description, numerous specific details are provided in order to provide a thorough understanding of implementation manners of the present disclosure. However, one skilled in the art will appreciate that the technical solutions of the present disclosure may be practiced without one or more of the specific details, or that other methods, materials, apparatuses, etc. may be adopted. In other instances, well-known technical solutions are not shown or described in detail to avoid obscuring aspects of the present disclosure. The same reference numerals in the drawings denote the same or similar structures, and thus their detail descriptions will be omitted.

The terms “a”, “an”, “the”, “said” and “at least one” are used to indicate the existence of one or more elements/components/etc.; and the terms “including”, “having” and “providing” are used in an open-ended inclusion and refer to the existence of additional elements/components/etc., in addition to the listed elements/components/etc.

In the pixel driving circuit of the related art, the light-emitting driving subcircuit includes a transistor T3, a gate of the transistor T3 is connected to an initializing circuit, one of a source and a drain of the transistor T3 is connected to a reference voltage signal ELVDD, and the other of the source and drain of the transistor T3 is connected to a light-emitting element. A threshold voltage (Vₜₕ) of the transistor T3 is prone to drift, which affects the magnitude of an operating current of the light-emitting element, thus resulting in a high probability of flicker when an OLED display is displaying at a low refresh rate and affecting the visual experience.

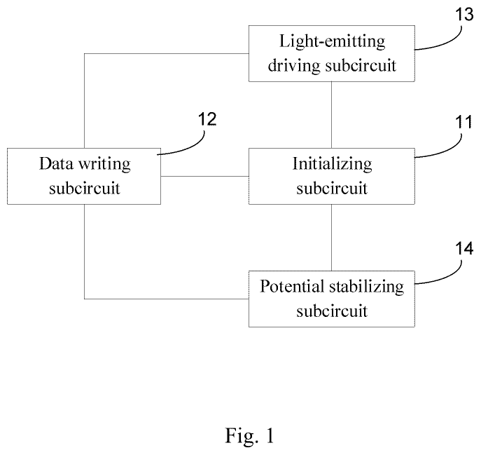

The present disclosure discloses a pixel driving circuit. As shown in FIG. 1, the pixel driving circuit includes an initializing subcircuit 11, a data writing subcircuit 12, a light-emitting driving subcircuit 13 and a potential stabilizing subcircuit 14. The potential stabilizing subcircuit 14 is connected to the data writing subcircuit 12 and the initializing subcircuit 11, respectively. The initializing subcircuit 11 includes a capacitor. The light-emitting driving subcircuit 13 includes a light-emitting element. The above initializing subcircuit 11 is respectively connected to the data writing subcircuit 12, the light-emitting driving subcircuit 13 and the potential stabilizing subcircuit 14. The data writing sub-circuit 12 is connected to the light-emitting driving subcircuit 13.

The above initializing sub-circuit is configured to perform initialization processing on the above capacitor and the above light-emitting element, respectively. The data writing subcircuit is configured to write the data signal voltage into the above capacitor. The light-emitting driving subcircuit is respectively connected to the above initializing subcircuit and the above data writing subcircuit, and is configured to drive the above light-emitting element to emit light. The data signal voltage is a potential corresponding to a data signal DATA.

The above initializing subcircuit is respectively connected to a first scanning signal Sₙ₋₁, a third scanning signal Sₙ₊₁, a first reference voltage signal VINT and a second reference voltage signal ELVDD. The above data writing subcircuit is respectively connected to the data signal DATA and a second scanning signal Sₙ. The above light-emitting driving subcircuit is respectively connected to a fourth scanning signal EN, the above second reference voltage signal ELVDD and a third reference voltage signal ELVSS. The potential stabilizing subcircuit is connected to a third scanning signal Sₙ₊₁.

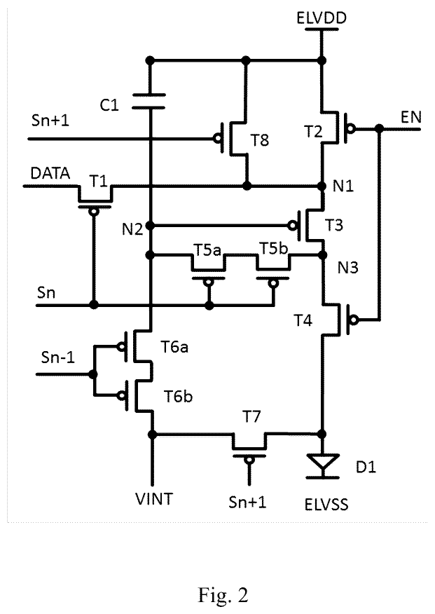

Referring to FIG. 2, the initializing subcircuit includes a capacitor C1 and a sixth transistor connected to each other, and the initializing subcircuit further includes a seventh transistor T7. The data writing subcircuit includes a first transistor T1, a third transistor T3 and a fifth transistor connected in sequence. The above light-emitting driving subcircuit includes a second transistor T2, the third transistor T3, a fourth transistor T4 and a light-emitting element D1 connected in sequence. The potential stabilizing subcircuit includes an eighth transistor T8. The above first transistor, second transistor and third transistor are jointly connected to form the above first node N1. Both the gate of the eighth transistor T8 and the gate of the seventh transistor T7 are connected to the above third scanning signal Sₙ₊₁.

In this embodiment, the fifth transistor and the sixth transistor are dual gate transistors. That is, the fifth transistor includes a transistor T5a and a transistor T5b connected to each other. The sixth transistor includes a transistor T6a and a transistor T6b connected to each other. The present application does not limit the types of the fifth transistor and the sixth transistor.

With continued reference to FIG. 2, specifically, a first electrode of the first transistor T1 is connected to the data signal DATA. A second electrode of the first transistor T1, a second electrode of the second transistor T2 and a first electrode of the third transistor T3 are connected to form the first node N1. A gate of the first transistor T1 and a gate of the fifth transistor are both connected to the second scanning signal Sₙ.

A gate of the third transistor T3 is connected to the initializing subcircuit to form a second node N2. Specifically, the gate of the third transistor T3, a second end of the capacitor C1 and a first electrode of the sixth transistor are jointly connected to form the second node N2. A first electrode of the fifth transistor is connected between the second end of the capacitor C1 and a first electrode of the sixth transistor. A second electrode of the sixth transistor is connected to the first reference voltage signal VINT. A second electrode of the fifth transistor, a second electrode of the third transistor T3 and a first electrode of the fourth transistor T4 are connected to form a common node N3.

A first end of the capacitor C1, the first electrode of the eighth transistor T8 and a first electrode of the second transistor T2 are all connected to the second reference voltage signal ELVDD. The second electrode of the eighth transistor T8 is connected between the second electrode of the first transistor T1 and the node N1.

Both a gate of the second transistor T2 and a gate of the fourth transistor T4 are connected to the fourth scanning signal EN. A gate of the sixth transistor is connected to the first scanning signal Sₙ₋₁. Both a second electrode of the fourth transistor T4 and a second electrode of the seventh transistor T7 are connected to an anode of the light-emitting element D1. A first electrode of the seventh transistor T7 is connected to the first reference voltage signal VINT. A cathode of the light emitting element D1 is connected to the third reference voltage signal ELVSS.

It can be known from the above structure that the first scanning signal Sₙ₋₁ controls the on and off of the sixth transistor. The second scanning signal Sₙ controls the on and off of the first transistor T1 and the fifth transistor, respectively. The third scanning signal Sₙ₊₁ controls the on and off of the seventh transistor T7 and the eighth transistor T8, respectively. The fourth scanning signal EN is configured to control the on and off of the second transistor T2 and the fourth transistor T4 respectively, that is, to control the on and off of the second transistor T2 and to control the on and off of the fourth transistor T4.

In this embodiment, the above potential stabilizing subcircuit is configured to control the eighth transistor to be conducted during a preset operating period of the pixel driving circuit to write the above second reference voltage signal into the above first node. The above preset operating period may be when the anode of the light-emitting element is reset (that is, initialization action is performed on the anode), or during the black insertion phase. Generally speaking, flicker phenomenon may appear on the OLED display panel at low frequencies. Generally, the flicker phenomenon may be improved by means of inserting black, that is, inserting multiple black images in one frame (that is, the EN signal is off). Exemplarily, if the transistor controlled by the EN signal is a P-type TFT, that is, conducted at a low level, then turning off the EN signal means that the EN signal is at a high level.

The pixel driving circuit disclosed by the present embodiment enables the transistor T8 to be conducted under the control of the third scanning signal Sₙ₊₁ during the resetting of the anode of the light-emitting element or the black insertion phase, so that the potential of the second reference voltage signal ELVDD is written into the node N1, and threshold compensation is performed on the third transistor T3, the problem of the drift of the threshold voltage of the third transistor is improved, the threshold voltage of the third transistor is closer to the standard threshold voltage, and the impact on the magnitude of the current of the light-emitting element when emitting light caused by the drift of the threshold voltage of the third transistor is avoided, thereby improving the flickering problem of the display image and enhancing the display effect.

In this embodiment, a voltage corresponding to the above second reference voltage signal is greater than a voltage corresponding to the above first reference voltage signal, and the voltage corresponding to the above second reference voltage signal is greater than the voltage corresponding to the above third reference voltage signal. A potential of the above first reference voltage signal is the same as a potential of the above third reference voltage signal, and the potential of the above first reference voltage signal is opposite to the potential of the above second reference voltage signal. Exemplarily, the second reference voltage signal is a positive potential, and the first reference voltage signal and the third reference voltage signal are negative potentials.

It should be noted that, the first electrodes of all the above transistors may be the source or the drain, and the second electrode may also be the source or the drain. When the first electrode of the transistor is one of the source or the drain, the second electrode is then the other of the source and the drain.

All of the above transistors may be P-type thin film transistors or N-type thin film transistors. And all transistors in the circuit are of the same type, that is, all of them are P-type thin film transistors, or all of them are N-type thin film transistors. When all of them are P-type thin film transistors (P-type TFT), they are triggered at a low-level (the active level is a low level). When all of them are N-type thin film transistors (N-type TFT), they are triggered at a high-level (the active level is a high level).

It should be noted that, in this embodiment, the switching devices selected in the circuit design of this embodiment are all P-type TFTs, that is, the active level is a low level. However, the present application is not limited to this type of the transistor.

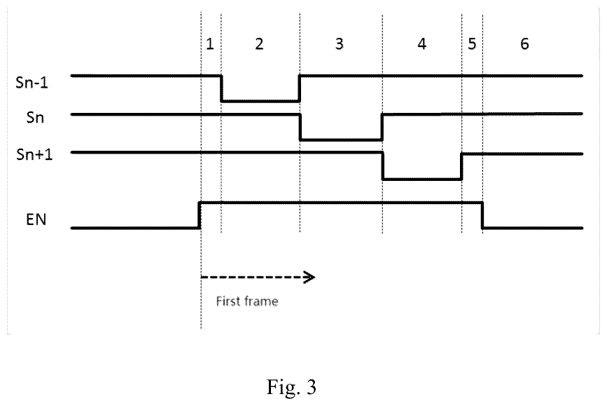

FIG. 3 is a schematic diagram of an operating timing sequence of a pixel driving circuit disclosed in an embodiment of the present application. As shown in FIG. 3, in the first period (i.e., period 1 in FIG. 3), the fourth scanning signal EN is at a high level, the second transistor T2 and the fourth transistor T4 are turned off, and the light emitting element D1 does not emit light, that is, the light emitting element D1 is in an off state.

In the second period (i.e., period 2 in FIG. 3), the first scanning signal Sₙ₋₁ is at a low level, and the sixth transistor is conducted, that is, the transistor T6a and the transistor T6b are conducted. The voltage corresponding to the first reference voltage signal VINT is written into the capacitor C1. The potential of the above second node N2 is reset to the voltage corresponding to the first reference voltage signal VINT, so that the above third transistor T3 is conducted.

In the third period (i.e., period 3 in FIG. 3), the second scanning signal Sₙ₋₁ is at a low level, and the first transistor T1 and the fifth transistor are conducted, that is, the transistor T5a and the transistor T5b are conducted. The voltage corresponding to the data signal DATA is written into the second node N2, but the threshold voltage of the second transistor T2 prevents the gate of T2 from charging to the potential corresponding to the DATA signal. The value of the upper limit of charging is (V_{DATA}+Vₜₕ₂), therefore the potential of the node N2 is (V_{DATA}+Vₜₕ₂), where V_{DATA} represents the potential corresponding to the data signal DATA, Vₜₕ₂ represents the threshold voltage of the second transistor T2, and Vₜₕ₂ is a negative value.

In the fourth period (i.e., period 4 in FIG. 3), the third scanning signal Sₙ₊₁ is at a low level, the seventh transistor T7 and the eighth transistor T8 are conducted, and the first reference voltage signal VINT initializes the anode of the light-emitting element D1, that is, resets the anode of the light-emitting element D1, and writes the above second reference voltage signal ELVDD into the above first node N1.

In the fifth period (i.e., period 5 in FIG. 3), the fourth scanning signal EN is at a high level, and the light-emitting element D1 does not emit light.

In the sixth period (i.e., period 6 in FIG. 3), the fourth scanning signal EN is at a low level, the second transistor T2 and the fourth transistor T4 are both conducted, and the light-emitting element D1 emits light.

From the second period to the sixth period, the third transistor T3 is always conducted.

In this embodiment, the above operating timing is periodic, and every 6 periods form one frame cycle. Therefore, the output result of the seventh period is the same as that of the first period, which will not be repeated in this embodiment. The first period to the sixth period are sequentially arranged in time sequence.

An embodiment of the present application further discloses a pixel driving method, which is applied to the pixel driving circuit disclosed in any one of the above embodiments. For the detailed structural features and advantages of the pixel driving circuit, reference may be made to the description of the above-mentioned embodiments, which will not be repeated here. The above methods include the following steps.

In step S110, initialization processing is performed on the capacitor and the light-emitting element, respectively, by using the initializing subcircuit.

In step S120, a data signal voltage is written into the capacitor by using the data writing subcircuit.

In step S130, a potential of the first node is reset by using the potential stabilizing subcircuit.

In step S140, the light-emitting element is driven to emit light by using the light-emitting driving subcircuit.

One frame cycle in which the circuit works includes a resetting phase, a charging phase and a light-emitting phase. The above step S110 corresponds to the resetting phase, the steps S120 and S130 correspond to the charging phase, and step S140 corresponds to the light-emitting phase.

An embodiment of the present disclosure also discloses a display panel, which includes the pixel driving circuit disclosed in any one of the above embodiments. For the detailed structural features and advantages of the pixel driving circuit, reference may be made to the description of the above-mentioned embodiments, which will not be repeated here.

In an optional embodiment, there are multiple light-emitting elements in the display panel. The solution of the present application can improve the problem of uneven display caused by the uneven brightness of multiple light-emitting elements, reduce the sense of visual flicker, and thus improve the display effect.

Some embodiments of the present disclosure further provide a display apparatus, which includes the above display panel.

The display apparatus provided by the embodiments of the present disclosure may be any apparatus that displays contents regardless of whether they are dynamic (for example, video) or fixed (for example, still images), and regardless of whether they are texts or images. More particularly, it is contemplated that the described embodiments may be implemented in or associated with a variety of electronic apparatuses. The variety of electronic apparatuses may include, for example, but not limited to, a mobile phone, a wireless device, a personal data assistant (PDA), a handheld or portable computer, a GPS receiver/navigator, a camera, a MP4 video player, a camcorder, a games console, a watch, a clock, a calculator, a television monitor, a flat panel display, a computer monitor, an automotive display (e.g., an odometer display, etc.), a navigator, a cockpit control and/or display, a display for camera views (e.g., a display for a rear-view cameras in a vehicle), an electronic photo, an electronic billboard or sign, a projector, an architectural structure, a packaging and an aesthetic structure, etc.

To sum up, the pixel driving circuit and the driving method thereof, the display panel and the display apparatus of the present application have at least the following advantages.

The pixel driving circuit and the driving method thereof, the display panel and the display apparatus provided by the present application enable the transistor T8 in the potential stabilizing subcircuit to be conducted under the control of the third scanning signal Sₙ₊₁ during the resetting of the anode of the light-emitting element or the black insertion phase, and reset the potential of the first node N1 by using the second reference voltage signal ELVDD, so that the threshold compensation for the third transistor T3 is realized, the problem of the drift of the threshold voltage of the third transistor T3 is improved, the threshold voltage of the third transistor T3 is closer to the standard threshold voltage, and the impact on the magnitude of the current of the light-emitting element when emitting light caused by the drift of the threshold voltage of the third transistor T3 is avoided, thereby improving the flickering problem of the display image and enhancing the display effect.

The above content is a further detailed description of the present disclosure in conjunction with specific embodiments, and it cannot be considered that the specific implementation of the present disclosure is limited to these descriptions. For those of ordinary skill in the art, without departing from the concept of the present disclosure, some simple deductions or substitutions may be made, all of which should be regarded as falling within the scope of protection of this disclosure.

1. A pixel driving circuit, comprising a light-emitting element, wherein the pixel driving circuit further comprises:
an initializing subcircuit, comprising a capacitor, wherein the initializing subcircuit is configured to respectively perform initialization processing on the capacitor and the light-emitting element;
a data writing subcircuit, connected to the initializing subcircuit, wherein the data writing subcircuit is configured to write a data signal voltage into the capacitor;
a light-emitting driving subcircuit, respectively connected to the initializing subcircuit and the data writing subcircuit, wherein the light-emitting driving subcircuit is configured to drive the light-emitting element to emit light; wherein the data writing subcircuit is connected to the light-emitting driving subcircuit to form a first node; and
a potential stabilizing subcircuit, respectively connected to the initializing subcircuit and the data writing subcircuit, wherein the potential stabilizing subcircuit is configured to reset a potential of the first node.

2. The pixel driving circuit according to claim 1, wherein the data writing subcircuit comprises a first transistor, the light-emitting driving subcircuit comprises a second transistor and a third transistor connected to each other, and the data writing subcircuit comprises the third transistor, and wherein the first transistor, the second transistor and the third transistor are connected together to form the first node.

3. The pixel driving circuit according to claim 1, wherein the initializing subcircuit comprises a seventh transistor, and the seventh transistor is respectively connected to the light-emitting element and a third scanning signal; and wherein the potential stabilizing circuit comprises an eighth transistor, and a gate of the eighth transistor is connected to the third scanning signal.

4. The pixel driving circuit according to claim 3, wherein the light-emitting driving subcircuit is connected to a second reference voltage signal, and the potential stabilizing subcircuit is configured to control the eighth transistor to be conducted during a preset operating period to write the second reference voltage signal into the first node.

5. The pixel driving circuit according to claim 3, wherein the initializing subcircuit comprises a sixth transistor, the sixth transistor is a dual gate transistor, gates of the sixth transistor are connected to a first scanning signal, a first electrode of the sixth transistor is connected to the capacitor, and a second electrode of the sixth transistor is connected to a first reference voltage signal.

6. The pixel driving circuit according to claim 4, wherein the initializing subcircuit is further connected to a first reference voltage signal; wherein during a fourth period of each frame cycle, the seventh transistor and the eighth transistor are conducted, a potential of an anode of the light-emitting element is reset to a potential corresponding to the first reference voltage signal, and the second reference voltage signal is written into the first node.

7. The pixel driving circuit according to claim 1, wherein the initializing subcircuit is respectively connected to a first scanning signal and a first reference voltage signal; wherein the data writing subcircuit is respectively connected to a data signal and a second scanning signal; and wherein the light-emitting driving subcircuit is respectively connected to a second reference voltage signal, a fourth scanning signal and a third reference voltage signal.

8. The pixel driving circuit according to claim 7, wherein a potential of the first reference voltage signal is the same as a potential of the third reference voltage signal, and a potential of the first reference voltage signal is opposite to a potential of the second reference voltage signal.

9. The pixel driving circuit according to claim 7, wherein a voltage corresponding to the second reference voltage signal is greater than a voltage corresponding to the first reference voltage signal, and the voltage corresponding to the second reference voltage signal is greater than a voltage corresponding to the third reference voltage signal.

10. A pixel driving method, wherein the pixel driving method is applied to a pixel driving circuit comprising a light-emitting element, and the pixel driving circuit further comprises:
an initializing subcircuit, comprising a capacitor, wherein the initializing subcircuit is configured to respectively perform initialization processing on the capacitor and the light-emitting element;
a data writing subcircuit, connected to the initializing subcircuit, wherein the data writing subcircuit is configured to write a data signal voltage into the capacitor;
a light-emitting driving subcircuit, respectively connected to the initializing subcircuit and the data writing subcircuit, wherein the light-emitting driving subcircuit is configured to drive the light-emitting element to emit light; wherein the data writing subcircuit is connected to the light-emitting driving subcircuit to form a first node; and
a potential stabilizing subcircuit, respectively connected to the initializing subcircuit and the data writing subcircuit, wherein the potential stabilizing subcircuit is configured to reset a potential of the first node, and
the method comprises:
performing initialization processing on the capacitor and the light-emitting element, respectively, by using the initializing subcircuit;
writing a data signal voltage into the capacitor by using the data writing subcircuit;
resetting a potential of the first node by using the potential stabilizing subcircuit; and
driving the light-emitting element to emit light by using the light-emitting driving subcircuit.

11. A display panel, wherein the display panel comprises a pixel driving circuit comprising a light-emitting element, and the pixel driving circuit further comprises:
an initializing subcircuit, comprising a capacitor, wherein the initializing subcircuit is configured to respectively perform initialization processing on the capacitor and the light-emitting element;
a data writing subcircuit, connected to the initializing subcircuit, wherein the data writing subcircuit is configured to write a data signal voltage into the capacitor;
a light-emitting driving subcircuit, respectively connected to the initializing subcircuit and the data writing subcircuit, wherein the light-emitting driving subcircuit is configured to drive the light-emitting element to emit light; wherein the data writing subcircuit is connected to the light-emitting driving subcircuit to form a first node; and
a potential stabilizing subcircuit, respectively connected to the initializing subcircuit and the data writing subcircuit, wherein the potential stabilizing subcircuit is configured to reset a potential of the first node.

12. (canceled)

13. The display apparatus according to claim 11, wherein the data writing subcircuit comprises a first transistor, the light-emitting driving subcircuit comprises a second transistor and a third transistor connected to each other, and the data writing subcircuit comprises the third transistor, and wherein the first transistor, the second transistor and the third transistor are connected together to form the first node.

14. The display apparatus according to claim 11, wherein the initializing subcircuit comprises a seventh transistor, and the seventh transistor is respectively connected to the light-emitting element and a third scanning signal; and wherein the potential stabilizing circuit comprises an eighth transistor, and a gate of the eighth transistor is connected to the third scanning signal.

15. The display apparatus according to claim 14, wherein the light-emitting driving subcircuit is connected to a second reference voltage signal, and the potential stabilizing subcircuit is configured to control the eighth transistor to be conducted during a preset operating period to write the second reference voltage signal into the first node.

16. The display apparatus according to claim 14, wherein the initializing subcircuit comprises a sixth transistor, the sixth transistor is a dual gate transistor, gates of the sixth transistor are connected to a first scanning signal, a first electrode of the sixth transistor is connected to the capacitor, and a second electrode of the sixth transistor is connected to a first reference voltage signal.

17. The display apparatus according to claim 15, wherein the initializing subcircuit is further connected to a first reference voltage signal; wherein during a fourth period of each frame cycle, the seventh transistor and the eighth transistor are conducted, a potential of an anode of the light-emitting element is reset to a potential corresponding to the first reference voltage signal, and the second reference voltage signal is written into the first node.

18. The display apparatus according to claim 11, wherein the initializing subcircuit is respectively connected to a first scanning signal and a first reference voltage signal; wherein the data writing subcircuit is respectively connected to a data signal and a second scanning signal; and wherein the light-emitting driving subcircuit is respectively connected to a second reference voltage signal, a fourth scanning signal and a third reference voltage signal.

19. The display apparatus according to claim 18, wherein a potential of the first reference voltage signal is the same as a potential of the third reference voltage signal, and a potential of the first reference voltage signal is opposite to a potential of the second reference voltage signal.

20. The display apparatus according to claim 18, wherein a voltage corresponding to the second reference voltage signal is greater than a voltage corresponding to the first reference voltage signal, and the voltage corresponding to the second reference voltage signal is greater than a voltage corresponding to the third reference voltage signal.
